(19) United States
(12) Patent Application Publication
(10) Pub. No.: US 2021/0407286 A1
(43) Pub. Date: Dec. 30, 2021

(54) Motion Sensing Traffic Sign Assembly

(71) Applicant: Eldwyn Brown, Queens Village, NY (US)

(72) Inventor: Eldwyn Brown, Queens Village, NY (US)

(21) Appl. No.: 16/917,127

(22) Filed: Jun. 30, 2020

(51) Int. Cl. G08G 1/04; F21V 23/04; F21S 9/03

(52) U.S. Cl. CPC G08G 1/04; F21Y 2105/12; F21S 9/037; F21V 23/0471

(57) ABSTRACT

A motion sensing traffic sign assembly for enhancing the visibility of traffic signs includes a traffic sign mounted on a stanchion to be visible to traffic. A control circuit is coupled to the traffic sign. A motion sensor is coupled to the traffic sign to detect traffic approaching the traffic sign and the motion sensor is electrically coupled to the control circuit. A plurality of light emitters is each coupled to the traffic sign. Each of the light emitters is turned on when the motion sensor senses motion to emit light outwardly from the traffic sign thereby enhancing visibility of the traffic sign for the traffic. A solar panel is coupled to the traffic sign and the solar panel is electrically coupled to the light emitters for powering the light emitters.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to traffic sign devices and more particularly pertains to a new traffic sign device for enhancing the visibility of traffic signs.

### BRIEF SUMMARY OF THE INVENTION

An embodiment of the disclosure meets the needs presented above by generally comprising a traffic sign mounted on a stanchion to be visible to traffic. A control circuit is coupled to the traffic sign. A motion sensor is coupled to the traffic sign to detect traffic approaching the traffic sign and the motion sensor is electrically coupled to the control circuit. A plurality of light emitters is each coupled to the traffic sign. Each of the light emitters is turned on when the motion sensor senses motion to emit light outwardly from the traffic sign thereby enhancing visibility of the traffic sign for the traffic. A solar panel is coupled to the traffic sign and the solar panel is electrically coupled to the light emitters for powering the light emitters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a motion sensing traffic sign assembly according to an embodiment of the disclosure.

FIG. 2 is a top view of an embodiment of the disclosure.

FIG. 3 is a front view of an embodiment of the disclosure.

FIG. 4 is a back phantom view of an embodiment of the disclosure.

FIG. 5 is a right side view of an embodiment of the disclosure.

FIG. 6 is a perspective view of an embodiment of the disclosure structured as a yield sign.

FIG. 7 is a perspective view of an embodiment of the disclosure structured as a wrong way sign.

### DETAILED DESCRIPTION OF THE INVENTION

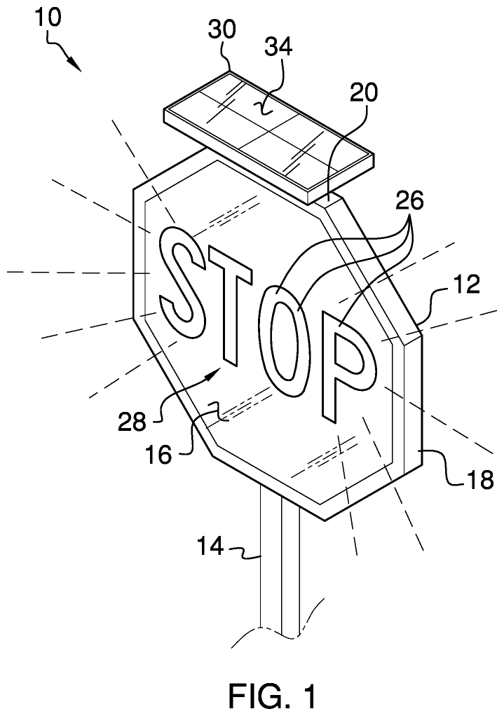

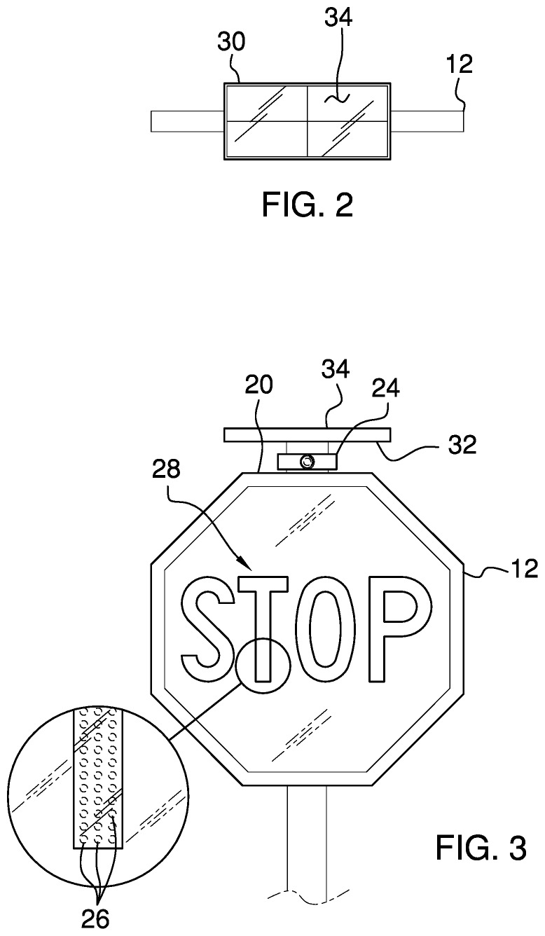

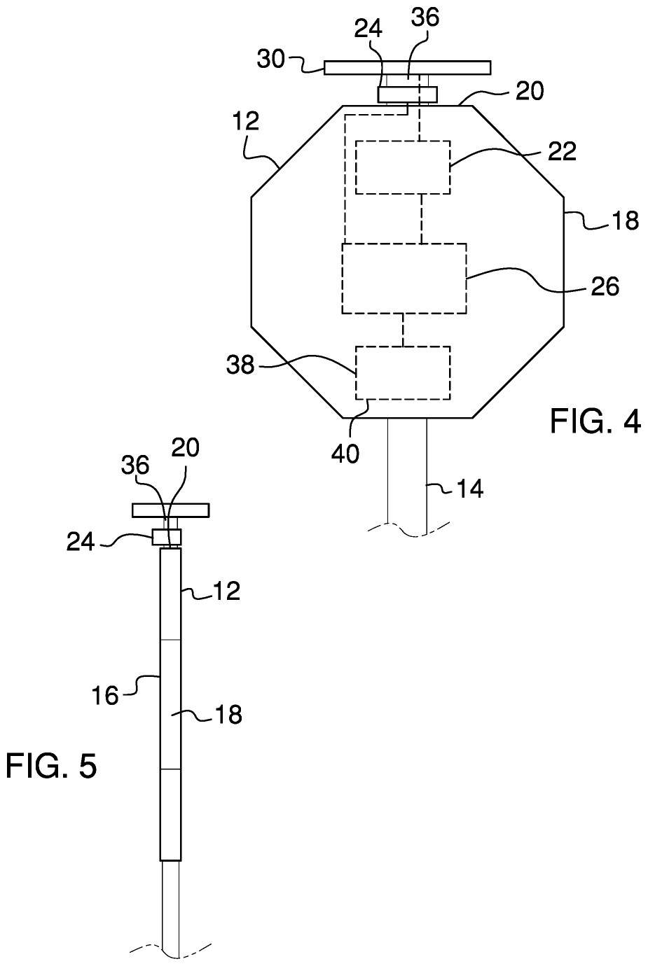

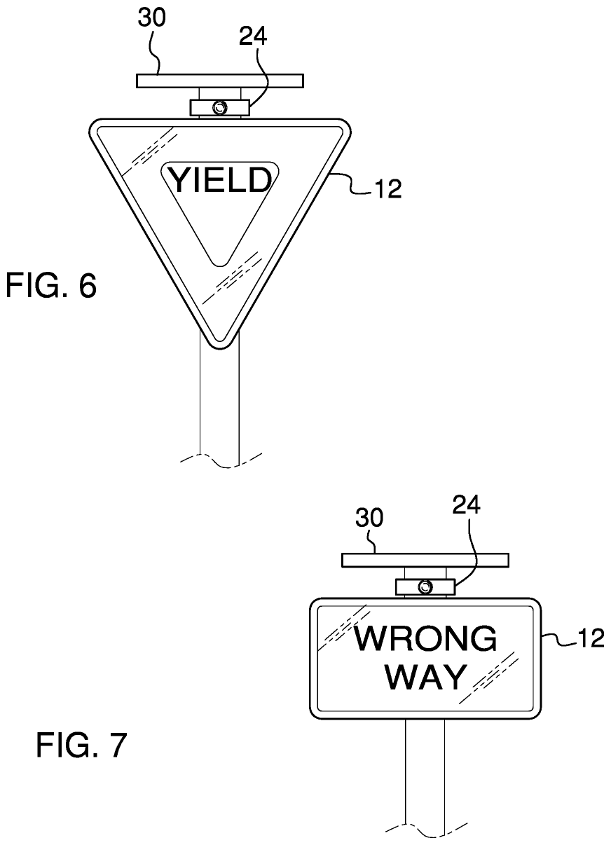

With reference now to the drawings, and in particular to FIGS. 1 through 7 thereof, a new traffic sign device embodying the principles and concepts of an embodiment of the disclosure and generally designated by the reference numeral 10 will be described.

As best illustrated in FIGS. 1 through 7, the motion sensing traffic sign assembly 10 generally comprises a traffic sign 12 that is mounted on a stanchion 14 thereby facilitating the traffic sign 12 to be visible to traffic. The traffic sign 12 has a first surface 16 and a perimeter edge 18, and the perimeter edge 18 has a top side 20. The traffic sign 12 may be a stop sign, a yield sign, a wrong way sign or any other traffic sign 12 commonly employed on public roadways. A control circuit 22 is coupled to the traffic sign 12 and the control circuit 22 receives an alert input.

A motion sensor 24 is coupled to the traffic sign 12 to detect traffic approaching the traffic sign 12. The motion sensor 24 is electrically coupled to the control circuit 22 and the control circuit 22 receives the alert input when the motion sensor 24 senses traffic approaching the traffic sign 12. Additionally, the motion sensor 24 is positioned on the top side 20 of the perimeter edge 18 of the traffic sign 12, and the motion sensor 24 is oriented to point in the same direction as the first surface 16 of the traffic sign 12. The motion sensor 24 may be an electronic motion sensor 24 of any conventional design and the motion sensor 24 may have a sensitivity range of approximately 200.0 feet. Additionally, the first surface 16 may be comprised of a light reflecting material that conforms to nation traffic safety laws.

A plurality of light emitters 26 is each coupled to the traffic sign 12 and each of the light emitters 26 is turned on when the motion sensor 24 senses motion. Thus, each of the light emitters 26 emits light outwardly from the traffic sign 12 thereby enhancing visibility of the traffic sign 12 for the traffic. Moreover, the plurality of light emitters 26 is arranged to form indicia 28 on the traffic sign 12 to communicate a traffic command to the traffic. The indicia 28 may comprise letters on a stop sign, a yield sign or any other letters or words commonly found on existing traffic signs. Each of the light emitters 26 is positioned on the first surface 16 of the traffic sign 12 and each of the light emitters 26 is electrically coupled to the control circuit 22. Additionally, each of the light emitters 26 may comprise an LED or the like.

A solar panel 30 is coupled to the traffic sign 12 such that the solar panel 30 is exposed to sunlight. The solar panel 30 is electrically coupled to the control circuit 22 for powering the control circuit 22. The solar panel 30 has a bottom surface 32 and a top surface 34, and the bottom surface 32 is coupled to a top 36 of the motion sensor 24 such that the top surface 34 is exposed to sunlight. A power supply 38 is coupled to the traffic sign 12, the power supply 38 is electrically coupled to the control circuit 22 and the power supply 38 comprises at least one battery 40. Moreover, the at least one battery 40 is electrically coupled to the solar panel 30 for charging the at least one battery 40. A speaker may be coupled to the traffic sign 12 and the speaker may be turned on when the motion sensor 24 senses motion. Additionally, the speaker may be employed on a wrong way traffic sign for issuing an audible warning to traffic that will potentially be going the wrong way.

In use, the control circuit 22 receives the alert input when the motion sensor 24 senses the traffic approaching the traffic sign 12. Thus, the plurality of light emitters 26 is turned on to enhance visibility of the traffic sign 12, especially at night. Additionally, the arrangement of the light emitters 26 into the indicia 28 ensures that the indicia 28 can be clearly read by the traffic under any conditions. In this way the light emitters 26 enhance the effectiveness of the traffic sign 12 with respect to controlling traffic. Each of the light emitters 26 is turned off after a pre-determined amount of time has passed, which is stored in the control circuit 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motion sensing traffic sign assembly being configured to illuminate when a vehicle approaches said assembly, said assembly comprising:
a traffic sign being mounted on a stanchion wherein said traffic sign is configured to be visible to traffic;
a control circuit being coupled to said traffic sign;
a motion sensor being coupled to said traffic sign wherein said motion sensor is configured to detect traffic approaching said traffic sign, said motion sensor being electrically coupled to said control circuit;
a plurality of light emitters, each of said light emitters being coupled to said traffic sign, each of said light emitters being turned on when said motion sensor senses motion wherein each of said light emitters is configured to emit light outwardly from said traffic sign thereby enhancing visibility of said traffic sign for the traffic; and
a solar panel being coupled to said traffic sign wherein said solar panel is configured to be exposed to sunlight, said solar panel being electrically coupled to said light emitters for powering said light emitters.

2. The assembly according to claim 1, wherein:
said traffic sign having a first surface and a perimeter edge, said perimeter edge having a top side;
said motion sensor is positioned on said top side of said perimeter edge of said traffic sign, said motion sensor being oriented to point in the same direction as said first surface of said traffic sign.

3. The assembly according to claim 2, wherein said plurality of light emitters is arranged to form indicia on said traffic sign wherein said plurality of light emitters is configured to communicate a traffic command to the traffic, each of said light emitters being positioned on said first surface of said traffic sign, each of said light emitters being electrically coupled to said control circuit, each of said light emitters being turned on when said control circuit receives said alert input.

4. The assembly according to claim 2, wherein said solar panel has a bottom surface and a top surface, said bottom surface being coupled to a top of said motion sensor wherein said top surface is configured to be exposed to sunlight.

5. The assembly according to claim 4, further comprising a power supply being coupled to said traffic sign, said power supply being electrically coupled to said control circuit, said power supply comprising at least one battery, said at least one battery being electrically coupled to said solar panel for charging said at least one battery.

6. The assembly according to claim 1, further comprising:
said control circuit receives an alert input;
said control circuit receives said alert input when said motion sensor senses traffic approaching said traffic sign; and
said plurality of light emitters is turned on when said control circuit receives said alert input.

7. A motion sensing traffic sign assembly being configured to illuminate when a vehicle approaches said assembly, said assembly comprising:
a traffic sign being mounted on a stanchion wherein said traffic sign is configured to be visible to traffic, said traffic sign having a first surface and a perimeter edge, said perimeter edge having a top side;
a control circuit being coupled to said traffic sign, said control circuit receiving an alert input;
a motion sensor being coupled to said traffic sign wherein said motion sensor is configured to detect traffic approaching said traffic sign, said motion sensor being electrically coupled to said control circuit, said control circuit receiving said alert input when said motion sensor senses traffic approaching said traffic sign, said motion sensor being positioned on said top side of said perimeter edge of said traffic sign, said motion sensor being oriented to point in the same direction as said first surface of said traffic sign;
a plurality of light emitters, each of said light emitters being coupled to said traffic sign, each of said light emitters being turned on when said motion sensor senses motion wherein each of said light emitters is configured to emit light outwardly from said traffic sign thereby enhancing visibility of said traffic sign for the traffic, said plurality of light emitters being arranged to form indicia on said traffic sign wherein said plurality of light emitters is configured to communicate a traffic command to the traffic, each of said light emitters being positioned on said first surface of said traffic sign, each of said light emitters being electrically coupled to said control circuit;
a solar panel being coupled to said traffic sign wherein said solar panel is configured to be exposed to sunlight, said solar panel being electrically coupled to said control circuit for powering said control circuit, said solar panel having a bottom surface and a top surface, said bottom surface being coupled to a top of said motion sensor wherein said top surface is configured to be exposed to sunlight; and
a power supply being coupled to said traffic sign, said power supply being electrically coupled to said control circuit, said power supply comprising at least one battery, said at least one battery being electrically coupled to said solar panel for charging said at least one battery.
